(19) United States
(12) Patent Application Publication
(10) Pub. No.: US 2006/0131484 A1
(43) Pub. Date: Jun. 22, 2006

(54) High-dynamic range image sensors

(76) Inventor: Mark Peting, Tigard, OR (US)

Correspondence Address: Dag Johansen, P.O. Box 7512, Menlo Park, CA, 94025, US

(21) Appl. No.: 11/016,689

(22) Filed: Dec. 17, 2004

(51) Int. Cl. H01J 40/14

(52) U.S. Cl. 250/214 R

(57) ABSTRACT

The dynamic range of existing CMOS image sensors is limited. The present invention introduces an extended dynamic range CMOS pixel sensor circuit. The extended dynamic range CMOS pixel sensor circuit is relatively similar to existing CMOS pixel sensors except that a charge pump has been added to recharge the pixel sensor when the pixel sensor is nearing charge depletion. Every firing of the charge pump is counted. To create a final output for the extended dynamic range CMOS pixel sensor circuit, the number of charge pump firings is combined with a final analog voltage reading of the pixel sensor circuit.

### FIELD OF THE INVENTION

The present invention relates to the field of electronic image sensor devices. In particular the present invention discloses novel CMOS based electronic pixel sensor designs.

### BACKGROUND OF THE INVENTION

Most early electronic pixel sensor devices are charge-coupled devices (CCD). A CCD pixel sensor is a semiconductor device that is sensitive to light. A CCD pixel sensor consists of a two-dimensional array of individual pixels that each capture a charge caused by photons striking the pixel element. As more photons strike a pixel, the more of charge is created such that the charge is proportional to the intensity of light striking the pixel.

CCD pixel sensors have been used to capture high-quality images. However, CCD pixel sensors are not manufactured with the industry standard Complementary Metal-Oxide-Semiconductor (CMOS) manufacturing processes used to create most digital integrated circuits. Thus, separate semiconductor parts were needed to provide the processing capabilities to a CCD-based image acquisition system. It was difficult to build CMOS pixel sensors due to fixed pattern noise created by manufacturing imperfections.

The creation of Correlated Double Sampling (CDS) circuits that compensate for the fixed pattern noise inherent in CMOS pixel sensors has allowed the creation of high-quality CMOS pixel sensors. Specifically, fixed pattern noise created by manufacturing variations between different pixels is compensated for by sampling the pixel during a reset period and after photon integration and calculating a difference value. The difference value eliminates noise created by manufacturing differences between the various pixel circuits. The basic operation of a CMOS pixel sensor circuit that employs correlated double sampling is as follows.

First, the CMOS pixel sensor circuit is reset to a ‘black’ voltage level by placing a charge on a photo sensor that allows current to flow when exposed to light. (Examples of photo sensors include photo-diodes and photo-gates.) Next, the photo sensor is exposed to light for a predefined amount of time. During this exposure phase, photo-generated current will deplete the charge placed on the photo sensor circuit and thus lower the voltage on the photo sensor. At the end of the exposure phase, the voltage level on the photo sensor is measured (a first voltage measurement). Then, the photo sensor is immediately recharged back to the black voltage level and the black voltage level on the photo sensor is measured and recorded (a second voltage measurement). A correlated double sampling (CDS) circuit then determines a light intensity using the two voltage measurements.

The correlated double sampling (CDS) circuit calculates a difference between the second voltage measurement and the first voltage measurement to determine a final voltage difference value. That final voltage difference value is proportional to the light intensity received by the photo sensor. If no light strikes the photo sensor then the charge on the photo sensor would remain the same such that the final voltage difference would be zero. If a large amount of light strikes the photo sensor, then the final voltage difference would be close to the reset voltage level. Note that if too much light is received, then the photo sensor will saturate by draining the entire charge. To prevent this from occurring, the exposure time must be reduced or the aperture must be made smaller.

A number of different CMOS pixel sensor designs that implement correlated double sampling have been created. Each different CMOS pixel sensor design has its own strengths and weaknesses. However, a feature that most CMOS image sensors have in common is a photo sensor that must have its capacitance charged.

In a conventional CMOS pixel sensor, the size of the capacitance of photo sensor limits the dynamic range of the pixel sensor circuit. Once the charge on the photo sensor has been drained, no more light will be detected. To avoid this problem, the camera system using an array of CMOS pixel sensors may reduce the size of the light aperture of the camera or reduce the exposure time. However, both reducing the light aperture and shortening the exposure time will reduce the light obtained in the low light areas of the image being captured. Thus, those areas of the image may simply appear dark. Therefore, the amount of photo sensor capacitance must be somewhat large in order to obtain a useful dynamic range from the pixel sensor.

However, with a fairly large capacitance value to hold a large charge, the voltage change on the photo sensor per received photon is low. Thus, the sensitivity of the CMOS pixel sensor is low. It would thus be desirable to create new CMOS pixel designs that are able to provide better sensitivity by increasing the voltage change per photon. Furthermore, these improved CMOS pixel sensors should provide a good dynamic range.

### SUMMARY OF THE INVENTION

As set forth in the background, the dynamic range of existing CMOS image sensors is limited. Extending the pixel range with larger capacitance on the sensor circuit reduces the voltage change per photon such that the sensitivity is reduced. Thus, it would be very desirable to have CMOS image sensors with a greater dynamic range.

The present invention introduces an extended dynamic range CMOS pixel sensor circuit. The extended dynamic range CMOS pixel sensor circuit is relatively similar to existing CMOS pixel sensors except that a charge pump has been added to periodically recharge the pixel sensor when the pixel sensor is nearing charge depletion. Since the charge pump may be repeatedly fired, there is no limit to the dynamic range of the extended dynamic range CMOS pixel circuit of the present invention.

During the light collection, every firing of the charge pump is counted. To create a final output for the extended dynamic range CMOS pixel sensor circuit, the number of charge pump firings is combined with a final analog voltage reading of the pixel sensor circuit.

Other objectives, features, and advantages of present invention will be apparent from the accompanying drawings and from the following detailed description.

### BRIEF DESCRIPTION OF THE DRAWINGS

The objects, features, and advantages of the present invention will be apparent to one skilled in the art, in view of the following detailed description in which:

FIG. 1A illustrates one possible embodiment of an improved sensitivity CMOS pixel sensor circuit with a high dynamic range.

FIG. 1B illustrates a first embodiment of a charge pump circuit that may be used in the improved sensitivity CMOS pixel sensor circuit of FIG. 1A.

FIG. 1C illustrates an alternate embodiment of an improved sensitivity CMOS pixel sensor circuit with a high dynamic range that uses column control to eliminate some circuitry.

FIG. 2 illustrates a flow diagram that generally describes how the pixel sensor circuit of FIG. 1A may operate.

FIG. 3A illustrates the voltage level of a photo sensor in the improved CMOS pixel circuit when no charge pump firings occur.

FIG. 3B illustrates the voltage level of a photo sensor in the improved CMOS pixel circuit when three charge pump firings occur.

FIG. 4A conceptually illustrates how the pixel sensor circuit voltage changes in the example of FIG. 3B may be determined using the digital and analog output values.

FIG. 4B conceptually illustrates how periodic analog voltage measurements may be used to perform a least squares fit in order to determine the switch noise that occurs when photo integration begins.

### DETAILED DESCRIPTION OF THE PREFERRED EMBODIMENT

Electronic pixel sensor apparatuses and methods and for constructing those electronic pixel sensor apparatuses are disclosed. In the following description, for purposes of explanation, specific nomenclature is set forth to provide a thorough understanding of the present invention. However, it will be apparent to one skilled in the art that these specific details are not required in order to practice the present invention. For example, the electronic pixel sensor apparatuses have been described with reference to the industry standard Complementary Metal-Oxide-Semiconductor (CMOS) manufacturing process. However, the same designs may be implemented with other electronic manufacturing processes. Furthermore, the present invention is described with reference to photo sensors. However, any other type of sensor circuit that generates current may be used.

### Dynamic Range Extended CMOS Pixel Sensor Design

As previously set forth, existing CMOS pixel sensor circuit designs use a photo sensor with a relatively large amount of capacitance in order to achieve a large dynamic range and prevent overflow. However, this large amount of capacitance results in a low voltage change per photon. To improve upon the CMOS pixel sensor design, certain embodiments of the present invention implement a CMOS pixel sensor that uses a smaller amount of capacitance coupled to the photo sensor. The smaller capacitance of such embodiments provides a greater voltage change per photon such that the sensitivity of the pixel sensor circuit may be improved.

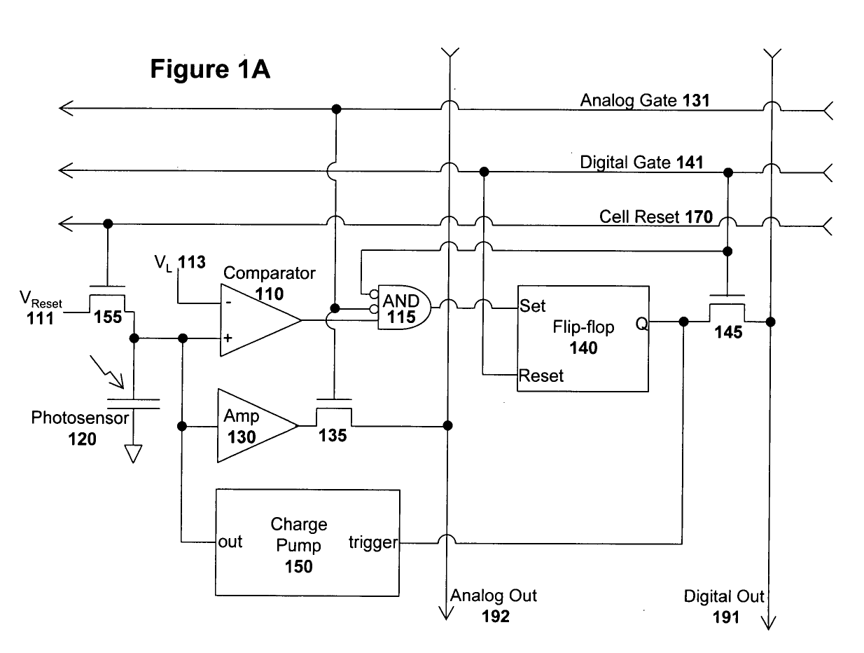

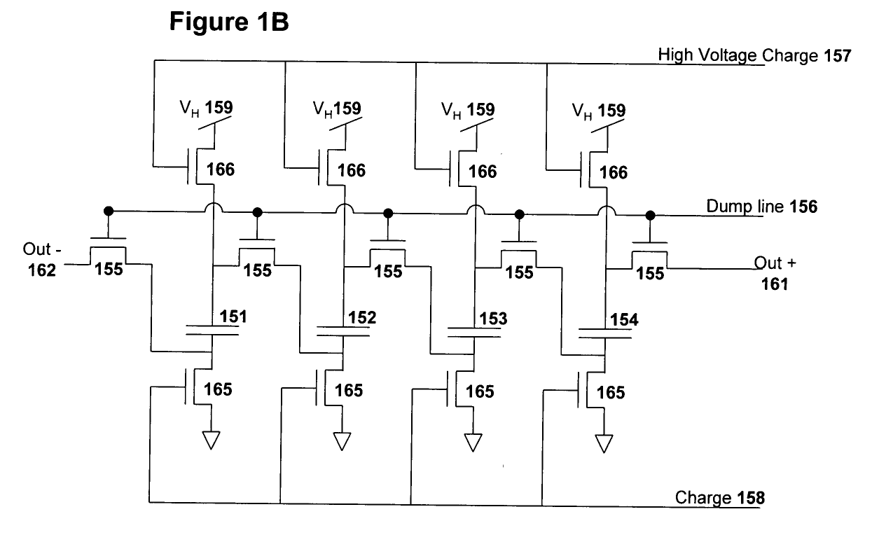

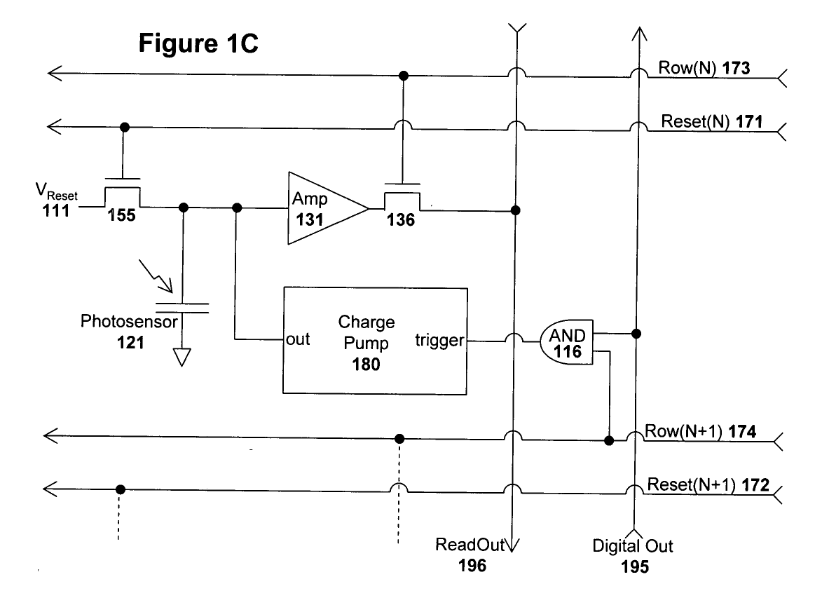

FIG. 1A illustrates a circuit diagram of a first embodiment of a dynamic range extended CMOS pixel sensor design according to the teachings of the present invention. The dynamic range extended CMOS pixel sensor of FIG. 1A begins with a photo sensor 120, an amplifier 130, and a read-out gate 135 that exist in traditional CMOS pixel sensor circuits. However, the photo sensor 120 and the amplifier 130 may be different than the photo sensor and amplifier used in a traditional CMOS pixel sensor circuit.

The photo sensor 120 may be a photo-gate, a photo-diode, or any other circuit that generates a photo-current. In some embodiments, the photo sensor 120 differs from CMOS pixel sensor circuits in that the photo sensor 120 has a smaller capacitance than the typical photo sensor used in a conventional CMOS pixel sensor circuit. In alternate embodiments of the pixel circuit that will be described in a later section, the photo sensor 120 may be may be replaced with any type of sensor circuit that generates current.

The amplifier 130 is used to amplify an output signal from the photo sensor 120. If the capacitance of the photo sensor 120 is smaller than the capacitance of a photo sensor in a conventional CMOS pixel sensor circuit, then the amplifier 130 may use a simpler amplifier circuit design than the amplifier circuit design used in conventional CMOS pixel sensor circuits. The reason that the amplifier 130 in the pixel circuit of the present invention may use a simpler circuit design is that amplifier 130 only has to handle a smaller dynamic range.

Finally, a read-out transistor gate 135 is used to select this particular pixel circuit for an analog read-out of photo sensor 120. The read-out transistor gate 135 is controlled by the ‘analog gate’ signal 131 that is controlled by external read-out circuitry (not shown).

As previously set forth, photo sensor 120 may have a capacitance that is lower than conventional CMOS pixel sensor circuits. Thus, the charge placed upon capacitance of photo sensor 120 will quickly be drained upon exposure to light. To prevent such an overflow condition, a comparator 110 compares the voltage on photo sensor 120 with a low voltage reference value V_{L} and if the voltage on photo sensor 120 drops below the low voltage reference value V_{L} then comparator 110 will set a flip-flop 140 that is used to count charge pump firings. The output of flip-flop 140 is coupled to a trigger on charge pump 150 such that charge pump 150 is fired in order to quickly recharge photo sensor 120. Thus, whenever the charge on photo sensor 120 is sufficiently drained such that the voltage on photo sensor 120 approaches the lower limit of the analog readout, the comparator 110 detects this and fires charge pump 150 that recharges the photo sensor 120 in order to raise the voltage of photo sensor 120 to a level near the reset level.

Referring to AND gate 115, note that the output from comparator 110 is logically ANDed with the inverse of the digital gate signal 141 that is high when a digital read-out is occurring and the inverse of the analog gate signal 131 that is high when an analog read-out is occurring. The logical ANDing with the inverse of the digital gate signal 141 ensures that the value of the flip-flop 140 can not change when a digital read-out is being performed. This prevents a read-out error from occurring by having the digital output value 191 change during read-out. Similarly, the logical ANDing with the inverse of the analog gate signal 131 ensures that charge pump 150 does not fire when an analog read-out is being performed.

The firing of charge pump 150 is latched by flip-flop 140 until external circuitry (not shown) activates digital gate signal 141 for a read-out of the digital value. Upon activation of digital gate signal 141 the output of flip-flop 140 is placed on digital out line 191. The external circuitry must periodically read the digital out line 191 such that the number of charge pump firing(s) is taken into account when determining the final value for the pixel.

Virtual High Voltage Charge Pump

FIG. 1B illustrates a circuit diagram of one possible embodiment of a charge pump 150 that may be used in the dynamic range extended CMOS pixel sensor design of FIG. 1A. The charge pump 150 allows for the metering of a very precise charge each time the charge pump is fired. In the dynamic range extended CMOS pixel sensor design of FIG. 1A, the charge pump 150 is used to recharge the photosensor 120 to by a consistent amount of charge.

In the charge pump embodiment of FIG. 1B, a higher voltage used to charge capacitors 151, 152, 153, and 154 means that smaller capacitance is required for those capacitors for the same amount of output charge. However, a smaller capacitor size reduces the Johnson noise (thermal noise) uncertainty of the charge pump circuit 150. Therefore, higher voltages used to charge capacitors 151, 152, 153, and 154 results in a very desirable higher charge-to-noise ratio.

In most circumstances, the charging voltage that can be applied to the charge pump circuitry is limited by the type of semiconductor process used. With most semiconductor processes, this amount is relatively low. To increase the effective charging voltage (and thus obtain the desirable higher charge-to-noise ratio), the circuit arrangement of FIG. 1B breaks a single virtual capacitor into N different capacitor sections.

In the example embodiment of FIG. 1B, a single virtual capacitor has been broken into four individual capacitors 151, 152, 153, and 154. During the charge cycle, the circuitry charges each of the individual capacitors 151, 152, 153, and 154 to the limit imposed by the semiconductor process. The charge pump is discharged by activating dump line 156 such that all of the transistors 155 that couple capacitors 151, 152, 153, and 154 are switched on. The activated transistors 155 combine capacitors 151, 152, 153, and 154 in series such that the in series capacitors act as one large capacitor that had been charged to a voltage level that is N times the normal voltage limit for that semiconductor processed used.

Note that the dump line 156 voltage presented to the gates of all of the transistors 155 should be made to ramp up slowly enough such that the discharge of capacitors 151, 152, 153, and 154 is gate limited. The triggering circuit for dump line 156 should pulse the dump line 156 while controlling the rising edge rate as well controlling how long the dump line 156 is held active. In this manner, no excessive voltage that may cause problems in the integrated circuit is ever present in the virtual high voltage charge pump circuit 150.

One possible difficulty with constructing the charge pump circuit of FIG. 1B is that the parasitic capacitances that exist in the active elements (such as transistors 155) create other charge pump like elements that do not have the N multiplication factor. Therefore, the capacitance of capacitors 151, 152, 153, and 154 in the charge pump need to be larger than the parasitic capacitance in the transistors. This requirement limits the smallest amount of charge that can be dumped. For example with an N=4 embodiment (as illustrated in FIG. 1B) in a 3.3 Volt design made from a 0.25 micron semiconductor manufacturing process, the charge generated needs to be 20 k e− to work properly. At this point the Johnson noise is only about 10 e− root mean squared (RMS) such that the noise is very small. This very low noise rate is helpful if some type of cancellation is being used to readout the pixel circuit where multiple charges of 20 k e− cancel each other. The very low noise rate is needed since even if the charges are canceling, the noise is still additive.

To integrate the charge pump circuit illustrated in FIG. 1B into the pixel circuit of FIG. 1A requires a small amount of additional circuitry. Specifically a controller is needed to control the charging and discharging of the charge pump circuit. To control the charge pump circuit illustrated FIG. 1B, the controller initially activates high voltage charge line 157 and charge line 158 in order to charge up the charge pump circuit. Then, the controller drops charge lines 157 and 158 at the end of a charging period. When charge lines 157 and 158 are low, the controller raises the dump line 156 to create the virtual high-voltage capacitor formed by coupling capacitors 151, 152, 153, and 154 in series. The controller holds the dump line 156 high for a predetermined time period to allow for the recharging of the sensor circuit. After recharging the sensor circuit, the controller drops the dump line 156 and then re-raises the charge lines 157 and 158 to begin recharging the charge pump.

A transistor may be used to couple the output of the charge pump in FIG. 1B to the sensor circuit. For example, a transistor may have its gate coupled to the output of the charge pump 150 in FIG. 1A, its drain coupled to V_{H}, and its source couple to out− 162; and out+ 161 would be coupled directly to the output of the charge pump in FIG. 1A.

### Basic Operation of Dynamic Range Extended Pixel Sensor

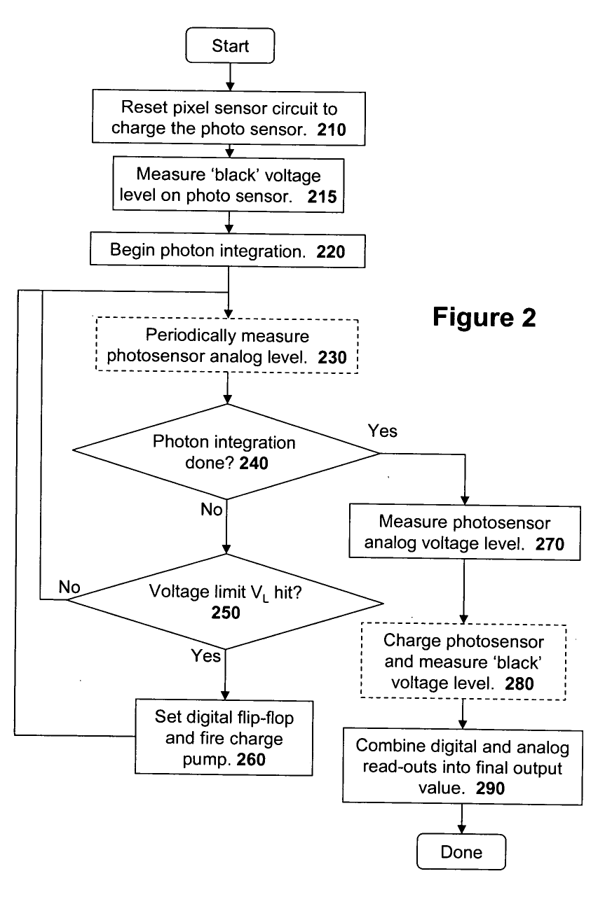

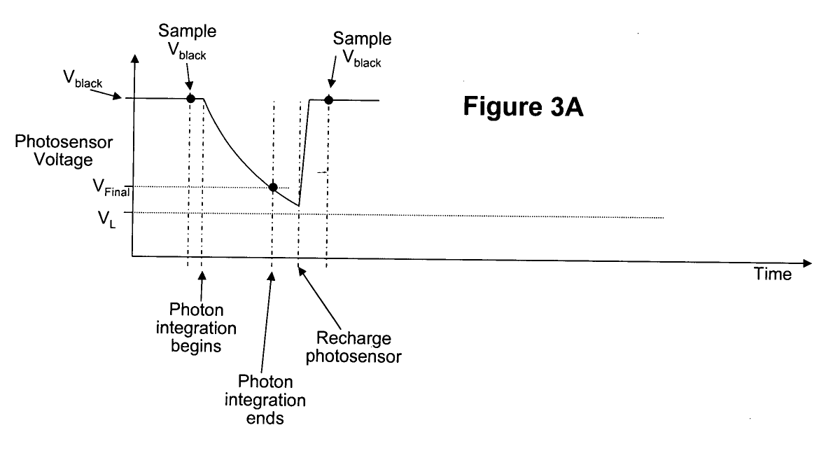

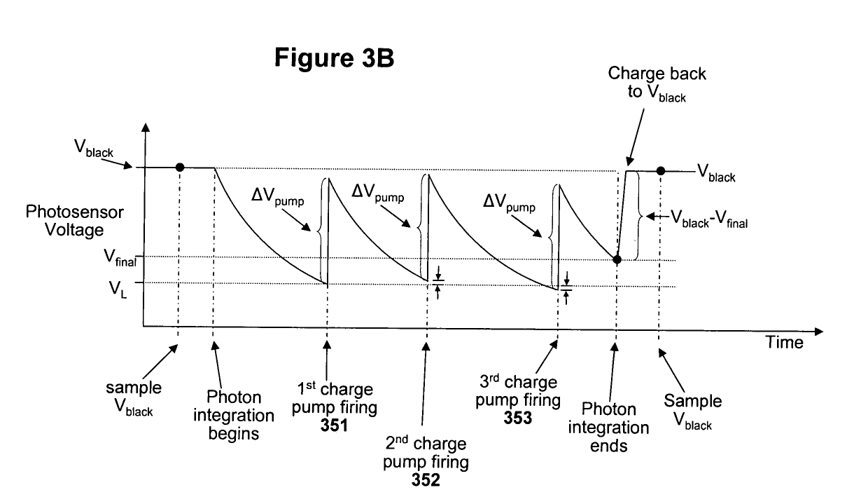

The operation of the extended dynamic range CMOS pixel sensor circuit of the present invention is similar to existing CMOS pixel sensors except for the periodic charge pump firings that recharge the photo sensor when the photo sensor is nearing charge depletion. Operation of the extended dynamic range CMOS pixel sensor will be described in detail with reference to FIGS. 1A, 2, 3A, and 3B. FIG. 2 illustrates a flow diagram that generally describes how the pixel sensor circuit of FIG. 1A may operate. FIGS. 3A and 3B illustrate two possible voltage graphs that specify the voltage of the photo sensor 120 during operation of the extended dynamic range CMOS pixel sensor of the present invention.

Pixel Sensor Circuit Reset

Referring to FIG. 2, the first step 210 in operation of the pixel sensor circuit of FIG. 1A is to place the pixel sensor circuit into a reset mode. Referring to FIG. 1A, this is performed by turning on reset transistor 155 using pixel circuit's reset line 170. Turning on reset transistor 155 uses a reset voltage source V_{Reset} 111 to charge the capacitance of photo sensor 120 and the line that couples photo sensor 120, the output of charge pump 150, the input of amplifier 130, and the input of comparator 110. The reset operation charges the photo sensor 120 a ‘black’ voltage level V_{black} that is generally less than the voltage level of the reset voltage source V_{Reset} 111 due to a voltage drop across reset transistor 155.

Next, at step 215, an external measurement circuit (not shown) measures and records the ‘black’ voltage level V_{black} on photo sensor 120. This ‘black’ voltage level V_{black} is measured and stored for later use. In some embodiments, the black voltage level V_{black} is sampled and measured several times in order to obtain a more accurate measurement by reducing the sampling noise.

Pixel Sensor Photon Integration

After measuring the voltage level of the ‘black’ voltage level V_{black} on photo sensor 120, the pixel reset transistor 155 is turned off and the pixel sensor circuit begins the photon integration stage at step 220. In some embodiments, a shutter is opened and light begins to strike the photo sensor 120. In other embodiments, the sensor is already being exposed to light such that simply the act of turning off the reset transistor 155 that charges the photo sensor 120 will begin the photon integration stage of step 220. As light strikes the photo sensor 120, the photons striking the photo sensor 120 will create a current within the photo sensor 120 known as a photo current. The photo current causes the charge on the photo sensor 120 to be depleted as illustrated in voltage graph of FIG. 3A.

Referring to the flow diagram of FIG. 2, the next three steps (steps 230, 240, and 250) are illustrated in a serial manner to simplify the explanation of the pixel sensor circuit. However, in an actual implementation of the pixel sensor circuit (such as the pixel sensor circuit implementation of FIG. 1A) these three steps would most likely occur concurrently.

In some embodiments, the pixel sensor circuit periodically measures the analog voltage level on the photo sensor 120 during photon integration as specified in step 230. These periodic analog voltage measurements may be used to improve the quality of the final output as will be described in a later section. However, not all embodiments will periodically measure the analog voltage level on the photo sensor 120 such that step 230 is illustrated with dotted lines.

At step 240, the pixel sensor circuit determines if the photon integration is complete. Generally, the photon integration occurs for a pre-determined amount of time. If the photon integration period has ended, the pixel circuit moves to step 270 to measure the analog voltage level on the photo sensor 120 to determine a final analog voltage output level V_{final}. The analog voltage level is read by activating analog gate line 131 and measuring the voltage on the analog out line 192 with correlated double sampling (CDS). FIG. 3A illustrates an example of integration period that ends with a measured final analog voltage output level V_{final}.

As set forth in FIG. 2, after measuring the analog level, the pixel sensor circuit may recharge the photo sensor 120 after photon integration and measure the black voltage level V_{black} again in optional step 280. The second measurement of the black voltage level V_{black} may be compared with the first measurement of the black voltage level V_{black} in order to compensate for the flicker noise of the amplifier. In some embodiments, the black voltage level V_{black} is sampled and measured several times in order to reduce the sampling noise.

Finally, at step 290, a final output value is generated by combining the digital and analog measurements into a single final output value. In the particular case of FIG. 3A, the digital output is zero since there were no charge pump firings caused by a low voltage level on the photo sensor. Thus, in the situation of FIG. 3A, only the analog level on analog output line 192 is used to generate the final output. Thus, the photon integration example of FIG. 3A is similar to photon integration in traditional CMOS pixel circuit systems.

Referring back to step 240 of FIG. 2, if the photon integration period has not yet completed then the pixel sensor circuit proceeds to step 250. At step 250, the pixel sensor circuit tests the voltage level of the photo sensor 120 to determine the low voltage reference value V_{L} has been reached. If the low voltage reference value V_{L} has not been reached, then the photon integration continues with a return back to step 230 to periodically measure the voltage level. Alternatively, the pixel sensor circuit may return back to step 240 if the periodic voltage measurements of step 230 have not been implemented in the particular embodiment.

Referring back to step 250 of FIG. 2, if comparator 110 in the pixel sensor circuit determines that the voltage level of photo sensor 120 has reached the low voltage reference value V_{L}, then the pixel circuit proceeds to step 260 to handle the largely discharged photo sensor 120. At step 260, the pixel sensor circuit sets digital flip-flop 140 and fires charge pump 150 in order to recharge the photo sensor 120 back up to a higher voltage level. Charge pump 150 will recharge photo sensor 120 by a known amount that is specified ΔVₚᵤₘₚ. FIG. 3B illustrates the voltage plot of a photo sensor in a pixel sensor circuit wherein at point 351, charge pump 150 is fired for the first time to recharge the photo sensor 120. Note that the voltage of photo sensor 120 jumps by the specified ΔVₚᵤₘₚ amount when charge pump 150 is fired.

After recharging the photo sensor 120, the pixel sensor circuit returns back to step 230 (or to step 240 if step 230 has not been implemented) to continue the photon integration. Note that in the example of FIG. 3B, the ΔVₚᵤₘₚ voltage increase has charged the photo sensor 120 voltage to a voltage level lower than V_{black}. However, ΔVₚᵤₘₚ may charge photo sensor 120 up to any voltage level that is less than or equal to V_{black}.

The charge pump 150 in the pixel sensor circuit may be fired a number of times during the photon integration period when bright light is experienced or when a very long exposure time is being used to obtain sufficient amounts of light for low-light areas of the image. For example, FIG. 3B illustrates the voltage plot of a photo sensor 120 that is recharged three times by the charge pump 150 before the photon integration period ends. During each recharge by charge pump 150, the voltage level on photo sensor 120 is increased by a consistent ΔVₚᵤₘₚ value. The consistent ΔVₚᵤₘₚ value is achieved from the charge pump circuitry such as the charge pump embodiment illustrated in FIG. 1B.

During photon integration, an external digital read-out circuit (not shown) periodically activates the digital gate line 141 to turn on transistor 141 in order to read out the value of flip-flop 140 on digital out line 191. Activated digital gate line 141 also resets flip-flop 140 back to zero. This external digital read-out circuit will count the number of times that the charge pump 150 is fired during the photon integration period. Note that the external digital read-out circuit must read out the value of flip-flop 140 on digital out line 191 faster than the photo sensor 120 can saturate such that every charge pump firing will be read.

Pixel Sensor Circuit Read-Out and Final Output

Referring back to step 240, the photon integration period will eventually end such that pixel sensor circuit moves to step 270. At step 270, the pixel sensor circuit measures the analog voltage level of photo sensor 120 by activating analog gate line 131 and measuring the voltage on the analog out line 192 with a read-out circuit. Next, at optional step 280, the system may recharge the photo sensor 120 to the black voltage level and measure that voltage level. The black voltage level may be sampled a number of times to reduce the noise on the sample. The difference between the black voltage level measured before the photon integration and this black voltage level measured after the photon integration is used to compensate for the flicker noise of the amplifier. Finally, the system proceeds to step 290 wherein the digital read-outs and the analog read-outs are combined to generate a final output value.

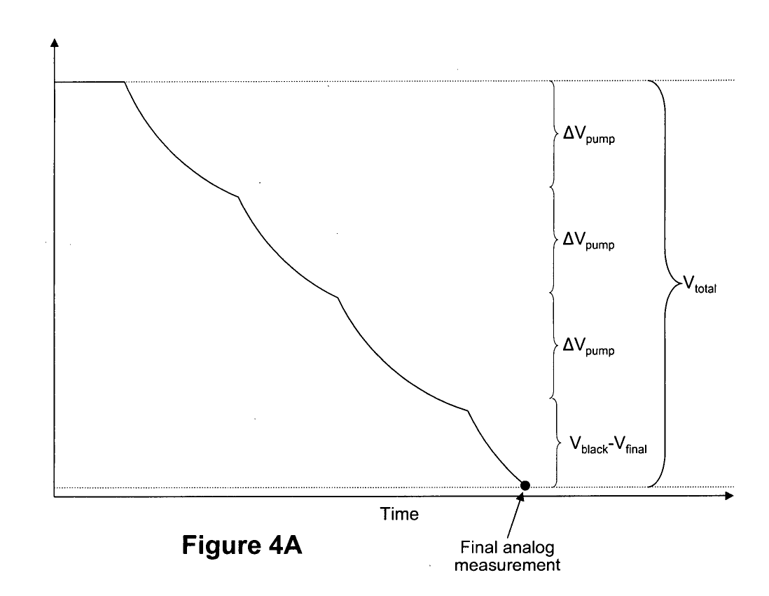

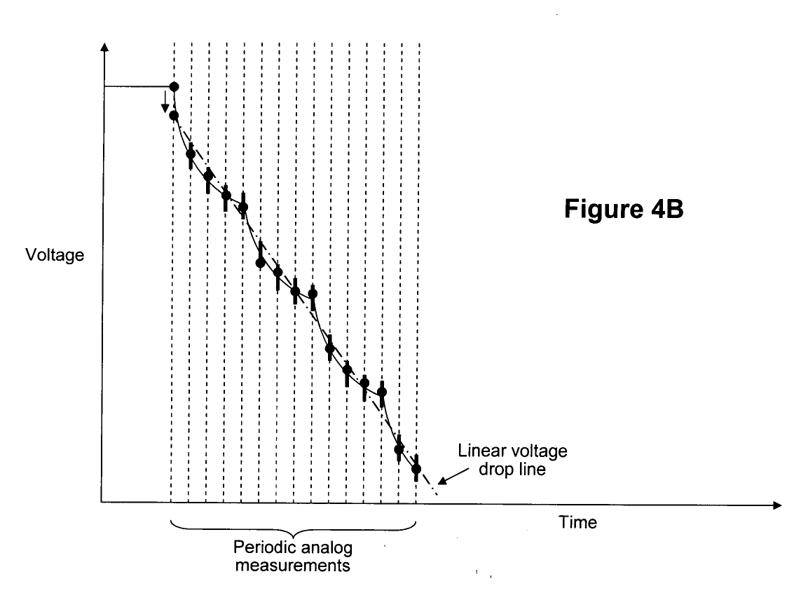

FIG. 4A conceptually illustrates how the digital read-outs and the final analog readout of the example in FIG. 3B may be combined to generate a final output value. The left side of FIG. 4A illustrates the cumulative voltage drops that occur on the photo sensor 120 during the photon integration period. That cumulative voltage drop can be calculated by multiplying the number of charge pump firings times the voltage increased by the charge pump firings (ΔVₚᵤₘₚ) and then adding the starting black voltage level V_{black} minus the final voltage level V_{final} as illustrated on the right of FIG. 4A. The voltage increases (ΔVₚᵤₘₚ) created by the charge pump firings and the difference between the black voltage level V_{black} and the final voltage level V_{final} added together to create a total voltage change Vₜₒₜₐₗ that is proportional to the light intensity.

Note that the consistent ΔVₚᵤₘₚ value from the charge pump 150 helps compensate for other possible inaccuracies in the pixel sensor circuit. For example, referring back to FIG. 1A, comparator 110 may not consistently activate at exactly the same low voltage reference value V_{L}. This example is shown by the second charge pump firing 352 and the third charge pump firing 353 in FIG. 3B wherein the comparator activated at a voltage level higher than low voltage reference value V_{L} and lower than low voltage reference value V_{L}, respectively. The situation illustrated during the third charge pump firing 353 will also often occur due to the fact that an analog read-out signaled on ‘analog gate’ line 131 or a digital read-out signaled on ‘digital gate’ line 141 will prevent the output of comparator 110 from passing through AND gate 115 until the read-out is completed.

By allowing the photo sensor to be recharged during the photon integration period, the pixel sensor circuit of the present invention extends the dynamic range over traditional CMOS pixel sensor circuits. Furthermore, reduced capacitance of the photo sensor means that there is a greater voltage change on the photo sensor per photon. Thus, the sensitivity of the pixel sensor circuit is improved over the prior art CMOS image sensors. The reduced capacitance also allows the A/D used for analog readout to have a lower bit depth than prior art CMOS image sensors.

Note that the various individual pixel sensor circuits in a pixel circuit array will operate in one of three different ranges: traditional CMOS sensor range, few charge pump firings range, and frequent charge pump firing range. A camera system that uses the pixel sensor circuit of the present invention may adapt its calculations depending on which of the different operating ranges are encountered.

In the traditional CMOS sensor range of the pixel circuit, there are no charge pump firings such that the digital output is zero. An example of this operating range is presented in the voltage diagram of FIG. 3A. If most of the different pixel circuits in an array are operating within this range, it is important to obtain high-quality analog read-outs. However, if most of the pixels are in the frequent charge pump firing range, then those few pixels in the traditional CMOS sensor range may simply output a zero value since the dynamic range of the photo sensor capacitor may be trivial when compared to many charge pump firings.

In the few charge pump firings operating range of the pixel circuit, both the digital output value (the number of charge pump firings) and the final analog output value are important. An example of this operating range is presented in FIG. 3B. Both the digital output value and the final analog output value are combined to create the final output value.

In the frequent charge pump firing operating range of a pixel circuit, the pixel circuit's charge pump is fired a number of times since a large amount of light has been received. At a certain point, the final analog output value of a pixel circuit in the frequent charge pump firing operating range is relatively unimportant since that very small analog output value is within the noise region of the voltage changes made by the frequent charge pump firings.

### Dynamic Range Extended Pixel Sensor Circuit Design Variations

The pixel sensor circuit of FIG. 1A represents only possible implementation of a pixel sensor circuit that extends the dynamic range with a charge pump. Many other design implementations that incorporate the teachings of the present invention are possible. This section will set forth some design modifications that may be implemented in certain. Furthermore, this section will provide information on techniques that may improve the quality of the images captured.

Column Controlled Charge Pump

At larger semiconductor feature sizes, the large layout area that is needed to include the charge pump, the comparator, and the flip-flop within in the pixel circuit of FIG. 1A may be unacceptable. For example, the extra components within the pixel circuit may result in a reduced fill factor (the ratio of the light sensitive area of a pixel circuit to the pixel circuit's total area). To adjust the pixel circuit design, some aspects of the pixel circuitry may be removed from the pixel circuit and handled outside of the pixel array circuitry.

FIG. 1C illustrates an alternative embodiment of the extended dynamic range pixel circuit wherein various different circuit elements of the original pixel circuit of FIG. 1A have been removed. The pixel circuit of FIG. 1C uses a column controller line to move the functions of the comparator 110 and flip-flop 140 of the pixel circuit set forth in FIG. 1A to a region outside of the pixel array. Specifically, external readout circuitry (not shown) located outside of the pixel circuit reads the analog voltage level of the photo sensor 121. The external readout circuitry analyzes voltage level and a column controller line is used to send a “fire charge pump” command back to the pixel circuit when necessary. This signal may also act as an indicator to increment a counter that keeps track of charge pump firings.

The pixel circuit of FIG. 1C operates as follows. First, an activation of Row (N) signal 173 will activate transistor switch 136 such that an external readout circuit (not shown) may read out the analog voltage value on photosensor 121. In one embodiment, an analog comparator tests the analog voltage value to determine if the analog voltage value of the photo sensor 121 has passed the low voltage reference value V_{L}. If the analog voltage value of the photo sensor 121 passed the low voltage reference value V_{L} then the external circuit may activate digital out line 195 to fire the charge pump 180.

In an alternate embodiment, an analog-to-digital converter in the external readout circuitry performs the comparator function to activate digital out line 195. Specifically, after the analog voltage value of the photo sensor 121 has been digitized, a comparison of the digital voltage value with a pre-determined digital voltage threshold value may trigger the activation of digital out line 195 in order to fire the charge pump 180.

The digital out line 195 is also coupled to charge pump 180 in order to fire the charge pump 180. To prevent the digital out line 195 from firing the charge pump in all of the pixel circuits of the same column, the digital out line 195 is logically ANDed by AND gate 116 with the next row readout signal 174. This clever usage of the next row readout signal 174 to both being the read out of the next row of pixel circuits and gate the “fire charge pump” signal for the previous row reduces the control lines needed for the pixel circuit. Digital out line 195 may also be coupled to a counter circuit that counts charge pump firings.

The pixel circuit design of FIG. 1C only results in a small amount of pixel circuit growth above that of a traditional CMOS pixel sensor circuit. However, the pixel circuit design of FIG. 1C retains the greatly improved dynamic range of the pixel circuit set forth in FIG. 1A.

One extra challenge with the pixel circuit embodiment of FIG. 1C is that there may be a much larger variation in the photosensor 121 voltage at the time of the charge pump 180 firing since the charge pump firing only happens at row readout time rather than as soon as the photosensor 121 voltage drops below the reference value V_{L}. Thus, it would be desirable to use the readout voltage (which is digitized upon readout) to calculate the actual charge transfer from the charge pump 180. This calculated charge transfer could then be added to the digitally accumulated pixel value rather than being able to simply count charge pump firings.

This approach calculate the actual charge transfer and adding it to an accumulated total would likely require an extra bit of analog-to-digital precision for readout since the photosensor voltage value may be larger than in the previous embodiment. Specifically, the photosensor 121 voltage may be just below V_{L} when a read out occurs such that the charge pump does not fire. Then, on the next read out pass the photosensor 121 voltage may have reached almost 2×V_{L} whereas the voltage of the photosensor 120 in the embodiment of FIG. 1A would not have been allowed to exceed V_{L}. This possibility of greater voltage levels on the photosensor requires that the capacitance of the photosensor 121 charge collection point be greater. However, in a larger feature size integrated circuit where this pixel circuit design is most useful, the capacitance of the photosensor 121 is already much higher than this limit due to the feature size.

Multiplexed Control and Data Lines

Referring back to FIG. 1A, in some embodiments, the row control lines could be multiplexed. For example, the analog gate line 131 and the digital gate line 141 could be multiplexed to reduce the number of control lines.

Similarly, the output lines can be multiplexed. Specifically, the analog out line 192 and digital out line 191 could be multiplexed such that the analog and digital output values are output on the same line.

Additional Information Capture in Pixel Circuit

In some embodiments, the information capture circuitry within the pixel sensor circuit will be more advanced. For example, the single bit flip-flop 140 in the embodiment FIG. 1A may be replaced with a multi-bit counter. In this manner, the charge pump firings may be counted internally within the pixel sensor circuit such that the digital output value does not have to be periodically scanned during image capture. At the end of the photon integration period, the pixel sensor circuit would then output a multi-bit digital counter value.

In another alternate embodiment, the single bit flip-flop 140 in the embodiment FIG. 1A may be replaced with an analog charge pump firing accumulator. The analog charge pump firing accumulator would accumulate the charge pump firings during the pixel circuit's operation. At the end of the photon integration, external circuitry would read-out the analog charge pump firing accumulator in order to take into account the multiple charge pump firings.

Sharing Circuit Elements between Pixel Sensor Circuits

In another alternate embodiment, the single charge pump 150 and/or the single comparator 110 in the embodiment FIG. 1A could be shared by a small group of pixel sensor circuits. This sharing of the charge pump circuitry is possible since the firing rate of the charge pump is fairly low in comparison to the amount of time required to perform an individual charge pump firing. Furthermore, this arrangement may also be used to facilitate encoding of the charge pump firings into less digital output bits. For example, if nearby pixels receive similar light then the system might be able to encode multiple charge pump firings together.

Since the maximum charge level on the photo sensor 120 only needs to be an amount that is similar to the amount of charge that can be produced by the charge pump 150, the capacitance of the charge accumulator of the photo sensor 120 can be lowered. If the capacitance of the charge accumulator of the photo sensor 120 is lowered, then the photo sensor circuit produces a greater voltage change per photoelectron than traditional CMOS light sensor circuits. Furthermore, this arrangement reduces the relative effects of amplifier noise and readout noise. If the charge pump 150 is be shared over multiple pixel circuits, the improved noise floor of the virtual high voltage charge pump disclosed in FIG. 1B would provide excellent results in such an shared charge pump embodiment.

Alternative Sensor Circuits

In the embodiments of FIG. 1A and FIG. 1C, the extended dynamic range pixel circuit is presented with a photo sensor that depletes a charge by creating photo current from light. The amount of photo current (that depletes the charge) is proportional to the intensity of the visible light. However, any other type of sensor device that that creates a current that can be used to charge or discharge a capacitor may be used instead of the photosensor. (The polarity of the charge pump is dependent on whether the sensor circuit is charging or discharging a capacitor.) Thus, the pixel circuit of the present invention may be used in many different types of sensor devices instead of just image sensors.

For example, an anode and cathode arrangement with a vacuum and a high-voltage field may be placed on top of the sensor circuit area such that any activity that dislodges an electron will cause that electron to accelerate across the high-voltage field and strike the receptive area of the sensor. The accelerated electron striking the receptive area of the sensor will induce a current within the sensor. With such an arrangement, an image sensor may use other regions of the electromagnetic spectrum such as the far-infrared.

Pixel Array Calibration

The pixel circuits of the present invention are designed to be used within a pixel array in order to create an image sensor circuit. However, inconsistencies during manufacture will prevent every pixel circuit from being manufactured exactly the same. The photo sensor may vary in sensitivity. The charge pumps may produce slightly different amounts of charge. Thus, it may be desirable to determine the different properties of the different pixel circuits by taking a series of test images of specified test patterns. The information from the test images may be used to calibrate the image sensor array.

To compensate for such manufacturing differences, the image sensor array could be exposed to a flat consistent image that is uniform across the entire image sensor array. With such an image, all of the pixel circuits would ideally output the same values. However, the subtle manufacturing differences between the pixel circuits will cause the outputs to vary. Therefore, a flat-fielding compensation equation may be created such that after applying the compensation equation, all of the different pixel circuits will output the same values when exposed to the same input.

Ideally, such a calibration would occur once at a manufacturing facility. The data needed to perform the compensation equation could be stored on in nonvolatile memory associated with the CMOS image capture circuit. Flash memory could be used to allow changes to be made. However, for high-end systems wherein the best quality pictures are required, the system could be calibrated in the field. The new compensation equation data would then be stored and used instead of the original compensation equation data.

In the system of the present invention, there may be non-static aspects that may require special calibration techniques. For example, the charge pumps may exhibit different characteristics when fired at different rates. Thus, calibration images should be taken at multiple different brightness levels to compensate for any differences caused by the charge pump firing rates.

Dynamic Exposure Time

The system of the present invention allows for the current state of the image sensor to be read during the image capture time. This is possible because in the image sensor system of the present invention, the ongoing readout that doesn't interfere with continued light collection. In effect, there can be many successive time points where the currently captured image is read out from the image sensor system and evaluated. A final noise reduced image capture may be selected once some criteria in the analyzed image are met.

One embodiment that uses the read-out during image capture capability is a camera system with a dynamically adjustable exposure time that automatically adapts to handle low-light situations. When a user attempts to take a picture with a dynamic exposure time camera system, the camera system would periodically read out and examine the image data being collected during exposure to determine if sufficient data has being captured or if the exposure time should be lengthened to capture more light. For example, the camera system may elect to continue the exposure until at least one positive digital read-out has been obtained (at least one charge pump has fired). This would indicate that at least one pixel circuit received enough light such that the charge on the photo sensor was depleted and it had to be recharged.

More advanced dynamic exposure time systems would use more sophisticated criteria to determine if the exposure time should be lengthened. For example, the camera system may continue to lengthen the exposure time until two or more different positive read-outs are obtained from different areas on the image array. This requirement would prevent a single point source of light from stopping the exposure. Thus, if a picture was taken on a darkened street except for a single streetlight, then the light directly from the area of that single street light would not stop the camera system from continuing to collection image data from the rest of the scene. Instead, the exposure would continue until at least two different areas of the image receive enough light such that the charge on the photo sensor is depleted. A setting on the camera system may be used to allow the user to specify the number of different areas that must be saturated before the exposure time is stopped.

Another method that may be used to determine how long of an exposure should be obtained is to locate the low light areas of the image and then ensure that those areas receive enough light to generate a good image. For example, a camera system may begin image capture and then identify a few areas that receive some light but not much. The camera may then keep the exposure going until the signal to noise ratio of those low light areas exceeds some minimum threshold.

There are many more possible criteria that may be calculated and used to determine if light collection should continue. Note that a camera system that uses a dynamic exposure time feature may require that the user place the camera system on a tripod or any other steady platform such as chair, table, fence, the ground, etc. This may be required since a long exposure time would greatly increase the chance of motion blur caused by movement of the camera system.

Multiple Time Slices of the Same Image

Another feature that could be provided using the ongoing readout during light collection capability is multiple times slices of the image. Specifically, the camera system may be configured to periodically read-out the entire image during light collection and store each image read-out data. In this manner, multiple different version of the same image will be created wherein more light is collected in each successive image.

This multiple time slice feature provided by the pixel circuit of the present invention provides several advantages. A few of the possible uses of the multiple time slice feature will be provided in this document. However, many more possible uses of the multiple time slice feature exist.

As set forth in the previous section, it is not always easy to automatically determine the optimal exposure period for an image. A processor in a camera system may use various heuristics to generate a relatively good result. However, there may have been other exposure times that would have provided a better image. With the multiple time slice capture system of the present invention, multiple different time slices may be captured and then carefully examined later in order to select the best image. For example, a human may later view all of the image time slices such that the human may select the best image during an image post-processing session.

In another embodiment, more, the information from the various different images may be combined in a manner that allows for a greater dynamic range of light to be viewed than otherwise possible. The present system generates pixel intensity values that are relative to the brightest pixel in the pixel array. With a long exposure time, a very large dynamic range of light intensity may be recorded. However, when the images captured with the system of the present invention are transformed into conventional formats, much of that dynamic range will be lost. It would therefore be useful to take advantage of the information before it is lost. One method is to combine different areas of different time slices.

For example, photograph taken on a street at night, a lighted sign may quickly provide enough light very quickly for a good image but darker areas in the same image would appear better if more light was collected. As more light is collected, the area of the lighted sign may generate brightness values so high that when the image is converted from the dynamic exposure image format to a conventional image format, those areas will become too saturated with light such that those areas will just appear as a white region. To create an image with the most detail, an early time slice of the lighted sign area may be combined with a later time slice of the darker areas such that the fine details in both regions are visible. Such an image may be considered artificial but nevertheless pleasing or useful.

A key advantage of the present invention over earlier systems is that the amount of noise is kept low. One could attempt to build a multiple time slice camera system with existing image sensors wherein ten images successively collected with one tenth the normal exposure time for each image. Those images could the successively be added together to achieve roughly similar results. However, as you successively add together the ten individual images, the amount of noise would increase with each added image. Thus, after adding together all ten images, the final image will have ten times the noise. The system of the present invention avoids such problems. The extended dynamic range system of the present invention makes it possible to capture many partial time images, without adding noise to the longer image capture and without ever becoming saturated.

### Improved Operation of Dynamic Range Extended CMOS Pixel Sensor

The operation of the pixel sensor circuit may be improved by employing a digital signal processor (DSP) to improve the quality of the output. For example, a digital signal processor may be used to average out multiple samplings to reduce noise. Furthermore, a digital signal processor may combine multiple analog read-outs made over time with a least-squares engine or other processing system to reduce the noise present on individual voltage measurements.

Referring to FIG. 3A, a photo sensor is charged to a black voltage level V_{black} and that black voltage level is sampled and measured. In a system that incorporates a digital signal processor to improve performance, the black voltage level V_{black} may be sampled and measured a number of times. The various black voltage level V_{black} measurements are then averaged together and held to determine a starting sense amplifier offset error. In this manner, the multiple black voltage level V_{black} read-outs are used to reduce noise level.

Referring back to FIG. 2, step 230 specifies that the pixel sensor circuit periodically measure the analog voltage level of the photo sensor during photon integration. (Note that this is in addition to the periodic digital read outs of charge pump firings.) All of these analog voltage measurements read out during photon integration combined with the number of charge pump firings can be processed to improved performance. FIG. 4B illustrates how the multiple analog measurements may be combined.

Referring to FIG. 4B, there will be a voltage step when the photon integration begins. The voltage step may be up or down. In the example of FIG. 4B, there is a downward voltage step. This voltage step is caused by the reset noise of opening the charging switch and not by a current change associated with photon detection. This charging switch reset noise may be significant such that it would be advantageous to compensate for it. Periodic sampling of the analog voltage on the photo sensor 120 during the photon integration may be used to cancel out that charging switch noise.

Referring again to FIG. 4A, a conceptually voltage diagram is illustrated with periodic analog voltage measurements super-imposed as dots on the photo sensor 120 voltage curve. Note that each analog measurement will not be exact due to sampling noise. Instead, each analog measurement will reside on a noise region around the real voltage value. In FIG. 4B, the noise region is illustrated as a dark vertical bar on the actual voltage graph. These periodic analog voltage measurements may be processed in a least squares engine to generate a theoretical linear voltage drop line. This linear voltage drop line can be used to determine the voltage step caused by the reset noise of opening the charging switch.

Note that the higher analog voltage measurement rate may require some adjustments to the pixel sensor circuit. For example, the higher analog voltage measurement rate may require an individual analog-to-digital (A/D) converter per pixel column. However, the analog-to-digital converter will likely have a low bit depth than prior art CMOS image sensors since the capacitance of the photo sensor 120 has been reduced from prior art designs.

The ability to measure/calculate initial and final sense amp offset error and reset error means that all of the error sources can be arbitrarily reduced by the square root of the number of samplings used. Thus a much lower noise floor is possible.

### Performance of Dynamic Range Extended CMOS Pixel Sensor

If exposure times allow the readout of each pixel sensor circuit 16 times during a capture cycle, and if the photo sensor accumulator capacitance is lowered, a root mean squared (RMS) noise floor of 10 e− is feasible. The maximum level is only limited by the rate at which the charge pump firings can be read out. Assuming that the maximum read-out level is 10 KHz, with 20 k e− per firing, at 1/100 sec exposure maximum readout level is 2e6 e−, giving a dynamic range of 2e5 or 106 db. For a 10 second exposure, dynamic range is 166 db. Thus, the CMOS image sensor of the present invention is ideal for static scenes in low-light conditions.

The power consumption dynamic range extended CMOS pixel sensor circuit may be slightly increased by the requirement of multiple analog-to-digital (A/D) conversion cycles for each pixel. However, this increased power consumption should be offset by the reduced accuracy requirements of the sense amplifiers and the analog-to-digital (A/D) converters with lower bit depths.

In some embodiments of devices constructed using the pixel circuit of the present invention, different operational modes could be implemented by the image acquisition system such that a user may select a desired trade off point between the noise floor performance and the power consumption. In such an embodiment, the operational mode setting that has a noise floor performance equal to the level of a conventional CMOS pixel sensor would consume less power than the conventional CMOS pixel sensor.

The foregoing has described a dynamic range extended CMOS pixel sensor circuit and methods for manufacturing dynamic range extended CMOS pixel sensor circuit. It is contemplated that changes and modifications may be made by one of ordinary skill in the art, to the materials and arrangements of elements of the present invention without departing from the scope of the invention.

We claim:

1. A method of creating an electronic sensor circuit, said method comprising:
creating a sensor to detect a phenomenon, said sensor charging or discharging a capacitance in response to said phenomenon;
creating a charge pump coupled to said sensor, said charge pump recharging or depleting charge from said capacitance during a sensing period when a voltage level on said capacitance passes a pre-determined threshold value.

2. The method of creating an electronic sensor circuit as claimed in claim 1, said method further comprising:
setting a flip-flop upon firing said charge pump.

3. The method of creating an electronic sensor circuit as claimed in claim 1 wherein said phenomenon comprises visible light.

4. The method of creating an electronic sensor circuit as claimed in claim 1, said method further comprising:
creating a comparator for comparing said voltage level on said capacitance with said a pre-determined threshold voltage level.

5. The method of creating an electronic sensor circuit as claimed in claim 1, said method further comprising:
creating a sense amplifier for aiding a measurement of said voltage level on said capacitance.

6. The method of creating an electronic sensor circuit as claimed in claim 5 wherein said measurement of said voltage level occurs at an end of said sensing period.

7. The method of creating an electronic sensor circuit as claimed in claim 5 wherein said measurement of said voltage level occurs periodically during said sensing period.

8. The method of creating an electronic sensor circuit as claimed in claim 2, said method further comprising:
creating external circuitry, said external circuitry periodically reading out said flip-flop during said sensing period.

9. The method of creating an electronic sensor circuit as claimed in claim 1 wherein a single charge pump circuit serves multiple different electronic sensor circuits.

10. The method of creating an electronic sensor circuit as claimed in claim 4 wherein a single comparator circuit serves multiple different electronic sensor circuits.

11. An electronic sensor circuit, said electronic sensor circuit comprising:
a sensor to detect a phenomenon, said sensor charging or discharging a capacitance in response to said phenomenon;
a charge pump coupled to said sensor, said charge pump recharging or depleting charge from said capacitance during a sensing period when a voltage level on said capacitance passes a pre-determined threshold value.

12. The electronic sensor circuit as claimed in claim 11, said electronic sensor circuit further comprising:
a flip-flop circuit, said flip-flop circuit set upon a firing of said charge pump.

13. The electronic sensor circuit as claimed in claim 11 wherein said charge on said phenomenon comprises visible light.

14. The electronic sensor circuit as claimed in claim 11, said electronic sensor circuit further comprising:
a comparator for comparing said voltage level on said capacitance with said pre-determined threshold value.

15. The electronic sensor circuit as claimed in claim 11, said electronic sensor circuit further comprising:
a sense amplifier, said sense amplifier for aiding a measurement of said voltage level on said capacitance.

16. The electronic sensor circuit as claimed in claim 15 wherein said measurement of said voltage level occurs at an end of said sensing period.

17. The electronic sensor circuit as claimed in claim 15 wherein said measurement of said voltage level occurs periodically during said sensing period.

18. The electronic sensor circuit as claimed in claim 12, said electronic sensor circuit further comprising:
external circuitry, said external circuitry periodically reading out said flip-flop during said sensing period.

19. The electronic sensor circuit as claimed in claim 11 wherein a single charge pump serves multiple electronic sensor circuits.

20. The electronic sensor circuit as claimed in claim 14 wherein a single comparator serves multiple different electronic sensor circuits.
